(19) United States
(12) Patent Application Publication
(10) Pub. No.: US 2026/0088509 A1
(43) Pub. Date: Mar. 26, 2026

(54) TRANSPONDER LABEL, SYSTEM AND METHOD FOR PRODUCING A TRANSPONDER LABEL FOR A VESSEL

(71) Applicant: Schreiner Group GmbH & Co. KG, Oberschleissheim (DE)

(72) Inventor: Conrad CLAUSS, München (DE)

(73) Assignee: Schreiner Group GmbH & Co. KG, Oberschleissheim (DE)

(21) Appl. No.: 19/112,642

(22) PCT Filed: Oct. 11, 2023
(86) PCT No.: PCT/EP2023/078182

§ 371 Date: Mar. 18, 2025

(30) Foreign Application Priority Data
Oct. 12, 2022 (DE) 10 2022 126 577.3

(51) Int. Cl. H01Q 7/00; G06K 19/077; H01Q 1/22; H01Q 9/26

(52) U.S. Cl. CPC H01Q 7/00; G06K 19/07786; H01Q 1/2225; H01Q 9/26

(57) ABSTRACT

A transponder label (2) for a container (3) comprises a carrier layer (20), and an RFID functional unit comprising an RFID chip (18) and an antenna structure (10) coupled thereto, which are coupled to the carrier layer (20). The antenna structure (10) has a first antenna section (11), a second antenna section (12) and an antenna loop (17), which is arranged between the first and second antenna sections (11, 12) and is coupled thereto. At least one of the two antenna sections (11, 12) comprises a first meander-shaped antenna arm (13) and a second meander-shaped antenna arm (14), which are arranged at a predetermined distance (D1, D2, D3) from each other and are electromagnetically coupled to each other.

The present invention relates to a transponder label for a container which provides reliable electronic labeling, for example for a pharmaceutical container, in a simple and cost-effective manner. The invention also relates to a system with such a transponder label. The invention further relates to a method for producing such a transponder label.

Labeling arrangements usually comprise a label which can be used for authorization, identification and authentication or for proof of origin. In particular, such labeling arrangements are used to provide information on the contents or for traceability. This applies, among other things, to containers in the pharmaceutical and medical sector, the contents of which need to be reliably labeled.

It is an objective underlying the invention to contribute to reliable and a cost-saving labeling of a container in a simple and cost-effective manner.

The objective is solved by the features of the independent patent claims. Advantageous embodiments are given in the respective dependent patent claims.

According to one aspect of the invention, a transponder label for a container comprises a carrier layer and an RFID functional unit which is arranged on the carrier layer. The carrier layer is formed, for example, as a plastic film, such as polyethylene terephthalate (PET). The RFID functional unit comprises an RFID chip and an antenna structure coupled to it. The antenna structure has a first antenna section and a second antenna section. The antenna structure further comprises an antenna loop arranged between and coupled to the first and second antenna sections. At least one of the two antenna sections comprises a first meander-shaped antenna arm and a second meander-shaped antenna arm, which are arranged at a predetermined distance from each other and electromagnetically coupled to each other.

The transponder label described can be used to achieve particularly reliable RFID functionalization of containers such as syringes, injection vials or pharmaceutical vials. In addition, the transponder label is also suitable for other medical or pharmaceutical containers or primary packaging. The transponder label can also be used for other objects for which electronic labeling is useful. The specifically designed and adjacent meandering antenna arms are inductively and capacitively coupled with each other, so that a controlled mode increase is set up and the antenna structure realizes a multimodal RFID antenna with several resonance frequencies.

These deliberately introduced resonance frequencies can be specifically tuned to an intended application so that a container provided with the transponder label can be reliably electronically identified and read despite different conditions or influences. It is a realization in connection with the present invention that RFID marking is challenging due to various external boundary conditions. Such external boundary conditions are, for example, given by the small dimensions of a primary container, so that the space available for the antenna is severely restricted. Furthermore, proximity to dissipative media, such as glass, water or salty aqueous solutions, can significantly reduce the performance of an RFID unit. In addition, the fill levels of the respective medications, for example, can vary even if the primary containers have identical dimensions.

Such boundary conditions lead to an undesirable frequency shift of the resonance frequency and can cause it to no longer be within the reading window of a reader. An RFID reader for reading an RFID unit is set up for a reading range of 865-868 MHz, for example, in accordance with official specifications. For example, a container in which only half of the contents are still present can no longer be read electronically over the distance required for the corresponding application and the data stored in the RFID chip cannot be accessed.

Using the transponder label described, several resonance frequencies are specifically provided by the antenna structure so that, despite a frequency shift in the resonance frequency, a different resonance can be used, which moves into the reading range of the reader as a result of the shift. This means that communication with a reader and reliable electronic identification of a primary container using RFID are also possible regardless of the boundary conditions described above. The antenna structure is designed to match the radiation characteristics and reading range of the intended reading device.

For example, the antenna structure has two meandering antenna arms on one side of the antenna loop, which form electromagnetically coupled resonators as dipole antennas. On the opposite other side of the antenna loop, for example, only one antenna arm is provided, which sets up a further dipole resonator. Together with the inner antenna loop, the antenna structure can thus provide four resonance frequencies, for example, depending on the coupling strength of the individual antenna components to each other, which are set up for the unfilled container at 500 MHz, 865 MHz, 975 MHz and 1050 MHz, for example. In this state, the resonance at 865 MHz would fall optimally within the reading range of the reader. At half the fill level, there is a frequency shift so that, for example, the resonance frequency of 975 MHz moves into the reading range of an RFID reader (in this example 865 MHz-868 MHz). If the container is completely full and has the maximum fill level, the associated further frequency shift can be taken into account with the original resonance frequency at 1050 MHz and the container can also be read electronically in this state. A frequency shift occurs with increasing filling level of a dissipative medium towards lower frequencies.

It is a finding in connection with the present invention that in an uncoupled system, a mode number can be specifically influenced by coupling antenna arms and, if necessary, an inner antenna loop. For example, at least one of the two resonances is split, resulting in three modes as a first approximation. If an inner antenna loop is also taken into account for such a system with antenna arms, six oscillation modes can be realized and used, for example.

According to an embodiment of the transponder label, both antenna sections each have a first meandering antenna arm and a second meandering antenna arm. The respective antenna arms are arranged at a predetermined distance from each other and are electromagnetically coupled to each other. This means that further resonant frequencies can be formed and provided by the antenna structure for readout. According to such an embodiment with two meandering antenna arms on both sides of the antenna loop, six resonance frequencies can be set up, which are preferably tuned to different edge connections in order to enable particularly secure and reliable electronic reading of the RFID chip and identification of the container. In addition, the antenna structure of the transponder label can also have three or more meandering antenna arms in a respective antenna section, which are spaced apart in a predetermined manner so that they couple electromagnetically with each other and provide a higher mode number of resonant frequencies.

According to a further embodiment of the transponder label, the respective first and second antenna arms have a rectangular meander shape, each with a plurality of rectilinear sections of predetermined length. The length of the individual sections as well as the total length of a respective antenna arm affect the inductive and capacitive coupling between each other and therefore determine the coupling strength and the setting of desired resonance frequencies. The rectangular meander shape of one or more antenna arms enables a particularly space-saving and dense antenna structure. Alternatively or additionally, the antenna arms can have an undulating or circular meander shape. In addition, the antenna arms can also have different meander shapes in sections or completely. The antenna arms are each designed in such a way that a predetermined electromagnetic coupling can be realized between them, which enables the controlled setting up of several resonance frequencies.

The antenna arms are connected to the inner antenna loop on the one hand and have free end sections on the other. The antenna arms can have a continuous linear design or alternatively have a flat antenna part at their free end sections, which can have a beneficial effect on the performance and reading range of the RFID functional unit.

In addition, the respective antenna arms can be connected to the inner antenna loop at a common or at different coupling points. Different coupling positions form different phase points and can also affect the setup of the different modes and be taken into account accordingly when forming the antenna structure.

Furthermore, a line width of the antenna arms also has an effect on the electromagnetic coupling and the formation of the resonant frequencies. Accordingly, the respective first and/or second antenna arm can have a line width of between 150 and 1000 μm. The line width refers to an extension parallel to the plane of the carrier layer. The line width therefore corresponds to the extension of the respective antenna arm when viewed from above on the transponder label.

The total length of the individual antenna arms determines the fundamental frequency of the uncoupled oscillation systems. Accordingly, the respective first and/or second antenna arm can, for example, have a total length of between 20-120 mm. The total length refers to an extension of the antenna arms along their predominant line shape from the free end section to the coupling point at which they couple with the antenna loop.

The length of the sections of the antenna arms over which they run parallel determines the degree of coupling strength. In these areas, both antenna arms couple both inductively and capacitively and thus cause a splitting of the resonant frequencies in relation to an uncoupled system. The length of these sections can range from almost 0 mm to the total length of the individual antenna arms.

In particular, a section length and/or a total length of the respective first and/or second antenna arm can be designed to match the container to be labeled. The same applies to a line width of the respective first and/or second antenna arm and a distance between two adjacent antenna arms, which are preferably designed to match the container to be labeled. The material of the container, the intended contents of the container and any fill levels of the contents can be taken into account and included in the formation of the antenna structure. The antenna structure can also be designed to be attached directly to a container closure or a container body, so that the antenna structure, in particular with regard to its length and width, and a circumference and/or a surface of the container intended for attachment can be designed to match each other.

The transponder label can also have security features that can indicate an opening or attempted manipulation of the container for which the transponder label is intended. For example, a perforation may be present and combined with cut-outs or branches, for example to leave clearly visible damage to the transponder label after the container has been opened. In particular, the transponder label can also be attached to a transition between a container closure and a container body, so that opening the container or attempting to remove the transponder label leads to targeted destruction. Alternatively or additionally, the transponder label can have a film or a film element that has a predetermined tear resistance.

In particular, the carrier layer of the transponder label comprises an adhesive layer so that the transponder label can be easily and reliably attached to the primary closure and/or the body of the container by means of adhesive. The transponder label can be single-layered or multi-layered. For example, it can be a wrap-around or wrap-around label that encloses a circumference of the container closure and/or the container body in relation to the longitudinal axis of the container. Alternatively, the geometry of the transponder label can also be such that it only partially covers a circumference of the container.

According to a further aspect, the invention comprises a use of an embodiment of the described transponder label for a container with a container body and a container closure, such as a syringe, an injection vial or a vial.

According to a further aspect of the invention, a system comprises a container, for example one of those described above with a container body and a container closure, and an embodiment of the described transponder label connected to the container body and/or the container closure.

In that the use and the system relate to or comprise an embodiment of the described transponder label, the described properties and features of the transponder label are also disclosed for the use and for the system and vice versa.

According to a further aspect of the invention, a method for producing a configuration of the transponder label comprises providing a carrier layer, and forming an RFID functional unit with an RFID chip and an antenna structure coupled thereto on the carrier layer. The antenna structure is formed with a first antenna section, a second antenna section and an antenna loop, so that it is arranged between the first and second antenna sections and coupled to them. At least one of the two antenna sections is formed with a first meander-shaped antenna arm and a second meander-shaped antenna arm, so that these are arranged at a predetermined distance from each other and are electromagnetically coupled to each other. The antenna structure of the RFID functional unit can be formed, for example, by etching aluminum and/or by printing a silver conductive paste on the carrier layer.

Since the method relates to the manufacture of an embodiment of the described transponder label, the described properties and features of the transponder label are also disclosed for the method and vice versa.

By means of the described transponder label, a clear and particularly reliable RFID functionalization of containers can be realized, which can take into account various boundary conditions, such as material, contents and different fill levels. It is therefore not necessary to provide complex label structures which, for example, provide for the formation of a label flag to improve read-out conditions.

It is a finding in connection with the present invention that, in the case of a label flag, it must be ensured, among other things, that the flag also protrudes from the primary container under all circumstances and is only surrounded by air. If this is not the case, i.e. if the flags of individual primary containers are pressed against the container to be labeled by neighboring containers or by the outer packaging, this results in an environment that deviates from air and the performance of an RFID component can be significantly impaired as a result. Such impairments can very easily lead to the RFID component no longer being reliably readable in the corresponding application environment.

Furthermore, regardless of the limitation of the RFID functionality, the provision of a formable label flag requires additional material and thus increases costs and can also make handling the container more difficult or hinder it during use, for example when administering a medication. By means of the described transponder label, the material requirement and the costs can be kept very low and, in addition, there are no adverse effects on the handling of a corresponding container to which the transponder label is attached.

With its special antenna structure, the transponder label described is designed to use the effect of coupled resonators to increase the number of possible oscillation modes and thus provide oscillation amplitudes in the desired frequency band of the given reader for different environmental conditions, such as different fill levels and different solutions due to salt content. The fact that the meandering antenna arms are coupled together as dipole resonators means that the antenna arms feel the influence of each other, so that they influence each other's electromagnetic properties. In relation to the overall system of the antenna structure, a multiplication of the possible oscillation modes can thus be set up in a targeted manner. This results in symmetrical and antisymmetrical modes whose position in the frequency space and whose characteristics in terms of their respective amplitude and quality depend on the natural frequencies of the uncoupled individual systems or antenna arms and the strength of the mutual coupling. The controlled multiple resonant frequencies make it possible to reliably read data on the RFID chip electronically, regardless of certain environmental conditions.

To further explain the mode coupling, the following two extreme cases can be considered, for example: a first extreme case is given, for example, by the container being completely empty or unfilled, so that there is the smallest possible influence of the environment and there is no frequency shift and damping due to a dissipative medium. The second extreme case is, for example, when the container is completely full, so that there is a maximum influence of the environment and the greatest possible frequency shift and maximum attenuation by the dissipative medium. In the case of water as a dissipative medium, a frequency shift greater than 200 MHz can result. With a typical half-width of resonant frequencies of approx. 20 MHz, it is understandable that a single-mode resonator only enables a usable resonance amplitude in the desired frequency band in one of the two cases.

With regard to the RFID frequency band specified by the authorities in Europe for reading RFID functionality, the permissible frequency band extends from 865-868 MHz and therefore has a bandwidth of 3 MHz. In other regions, such as the USA, for example, reading out RFID functionality is permitted in a frequency band of 902-928 MHz and therefore has a bandwidth of 26 MHz. Accordingly, the resonant frequencies of the transponder label can be adapted to the respective region for which it is intended in a later wound.

By designing the antenna structure of the transponder label with coupled resonance frequencies and specifically adapting the coupling to the intended applications, it can be achieved that in both cases a respective resonance mode is realized in the desired frequency band of the readout device both when completely filled and when not filled. This means that the multimodal antenna structure can be used to realize typical application reading ranges in different environmental situations. The antenna structure can be applied directly to the container using the transponder label.

In principle, two, three or more resonators or antenna arms can also be electromagnetically coupled together. The parameters responsible for the coupling strength, such as the line widths of the individual antenna arms, the distances between the lines of the antenna arms, the length of the individual antenna arms and the position of the connection points of the antenna arms to the inner antenna loop, can also be varied and adapted to the respective application.

In the following, embodiments of the invention are explained with reference to schematic drawings. They show:

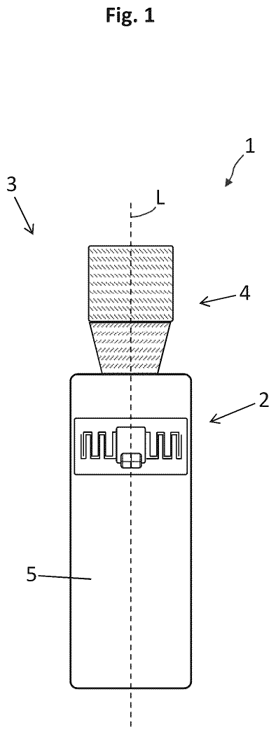

FIG. 1 an embodiment of a system with a container and a transponder label attached thereto,

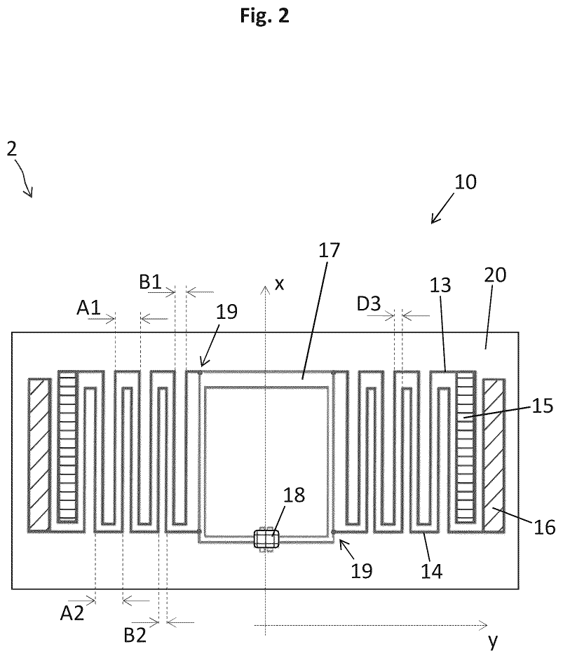

FIGS. 2-5 embodiments of the transponder label according to FIG. 1, and

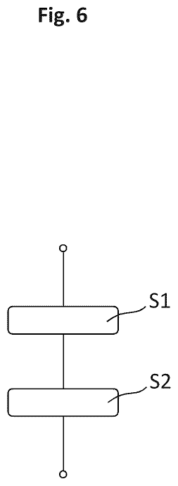

FIG. 6 a flowchart for a method for producing the transponder label according to FIGS. 1-5.

Elements of the same construction and function are marked with the same reference signs across the figures. For reasons of clarity, not all of the elements shown in all of the figures are marked with the corresponding reference symbols, possibly.

FIG. 1 shows a schematic side view of a system 1 with a container 3 and a transponder label 2 applied to the container 3. The container 3 comprises a container body 5 and a container closure 4, which is coupled to the container body 5 and is arranged above the container body 5 with respect to a longitudinal axis L. The transponder label 2 is attached to the container body 5 as shown in FIG. 1. Alternatively or additionally, the transponder label 2 may be attached to the container closure 4 and/or oriented at 90° or otherwise.

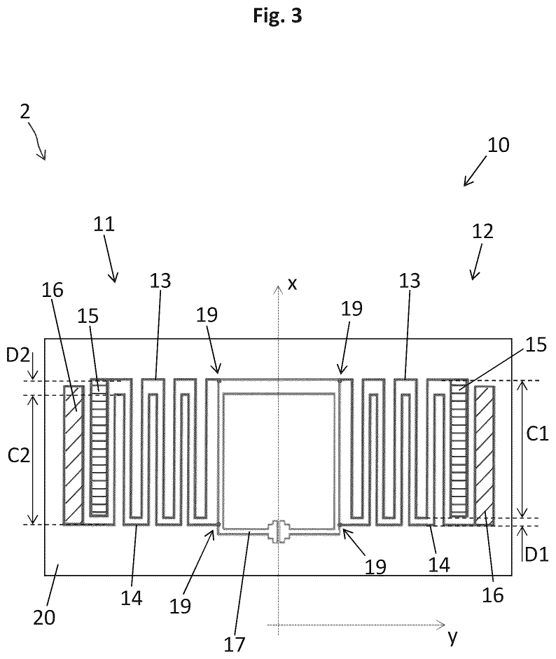

FIGS. 2-5 show embodiments of the transponder label 2 in a schematic top view. FIGS. 2 and 3 show an embodiment example of the transponder label 2, which comprises a carrier layer 20 and an RFID functional unit with an RFID chip 18 and an antenna structure 10 coupled to the carrier layer 20. The antenna structure 10 comprises a first antenna section 11, a second antenna section 12 and an antenna loop 17 arranged between and coupled to the first and second antenna sections 11, 12. Referring to FIGS. 2 and 3, the antenna loop 17 may also be referred to as the inner antenna loop, while the first antenna section 11 is coupled to the left and the second antenna section 12 is coupled to the right of it at different coupling points 19 with the inner antenna loop 17.

In the context of this description, terms such as “top” and “bottom” as well as “right” and “left” refer to an arrangement or orientation of the transponder label 2 as illustrated in the figures. Alternatively, a respective coordinate system with a vertical x-direction and a horizontal y-direction is shown in FIGS. 2-5.

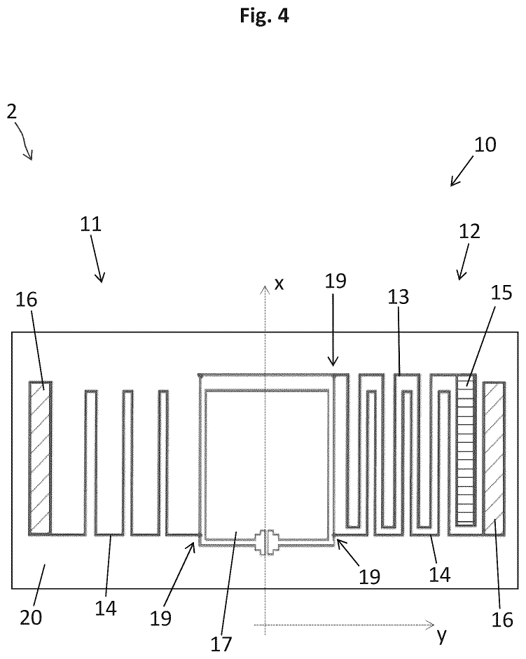

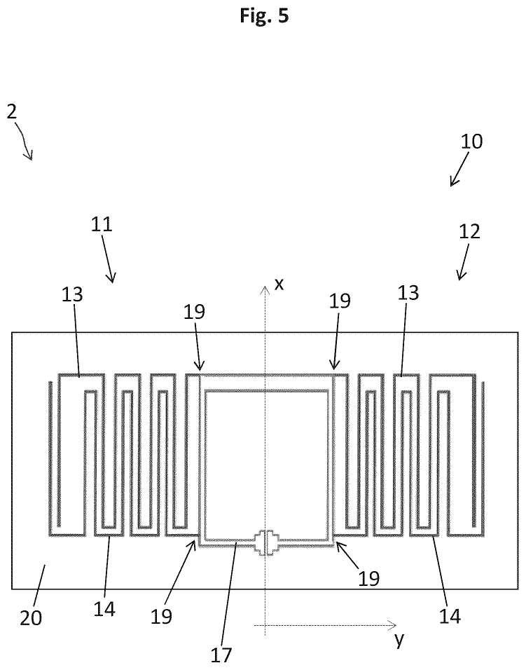

The two antenna sections 11 and 12 each have a first meander-shaped antenna arm 13 and a second meander-shaped antenna arm 14, which are arranged at a predetermined distance D1, D2, D3 from one another and are electromagnetically coupled to one another. The antenna arms 13, 14 each have a rectangular meander shape, with the respective second antenna arm 14 being arranged predominantly within the meander shape of the respective first antenna arm 13. The antenna arms 13, 14 are predominantly line-shaped and have a predetermined line width. At a respective free end, the antenna arms 13, 14 each have a flat antenna part 15 or 16, which can have a particularly beneficial effect with regard to a reading range and a performance of the RFID functional unit. Alternatively, the antenna arms 13, 14 can also have a continuous linear design (see FIG. 5). In addition, an antenna section 11, 12 can also have only one antenna arm 13 or 14 (see FIG. 4). Alternatively, an antenna section 11, 12 can also have three or more antenna arms 13, 14, which are partially or completely electromagnetically coupled to each other.

The antenna arms 13 and 14 are designed and arranged relative to each other in such a way that they couple inductively and capacitively with each other and set up a controlled number of resonant frequencies of the antenna structure 10. In this respect, the following parameters can influence the formation of the resonant frequencies: a line width of the respective antenna arm 13, 14; an overall length of the respective antenna arm 13, 14; an outer width A1, A2 of the respective antenna arm 13, 14 (see Fig. FIG. 2); an inner width B1, B2 of the respective antenna arm 13, 14 (see FIG. 2); horizontal and/or vertical distances D1, D2, D3 between the antenna arms 13, 14 (see FIGS. 2 and 3); a height C1, C2 of the respective antenna arms 13, 14 (see FIG. 3). In this context, horizontal distances or widths as well as vertical distances and heights refer to the x and y directions shown. FIG. 2 therefore illustrates essentially horizontal dimensions along the y-direction. FIG. 3 therefore illustrates essentially vertical dimensions along the x-direction. However, FIGS. 2-5 can also be understood as a top view, so that the x and y directions represent mutually perpendicular directions within a horizontal plane.

The line width of a respective antenna arm 13, 14 refers to the x-y plane shown and has a value between 150-1000 μm, for example. The total length of the respective antenna arm 13, 14 from the outer free end to a respective coupling point 19, at which the antenna arm 13, 14 is connected to the inner antenna loop 17, has a value between 20-120 mm, for example. The height C1, C2 of the respective antenna arm 13, 14 can, for example, have a value between 10-20 mm. The distances D1, D2 and D3 can each have a value corresponding to 10%-150% of the line width.

The antenna structures 10 described and illustrated each comprise a coupling of at least two meandering dipole antennas in the form of antenna arms 13, 14. Both antenna arms 13, 14 have similar resonant frequencies on their own. The respective coupling of the two antenna arms 13, 14 of one of the antenna sections 11, 12 is both inductive and capacitive and depends on the length of the parallel conductor sections, their spacing and the respective line widths. In addition, they couple into the inner antenna loop 17 at different phase points 19. By changing these parameters, the coupling strength can be varied in a targeted manner and thus the resonance behavior of the antenna structure 10 can also be specified in a controlled manner. By suitably varying the coupling strength, the antenna structure 10 can be tuned as an overall system to the specified environmental conditions in the intended application.

The antenna arms 13, 14 and the antenna loop 17 each influence each other with regard to their electromagnetic properties, so that the coupling determines the plurality of resonant frequencies and their characteristics. According to the embodiments shown in FIGS. 2-3 and 5, six different resonant frequencies are provided. In comparison, the embodiment of the antenna structure 10 according to FIG. 4 provides four different resonant frequencies for readout. Alternatively, the antenna structure 10 can also be designed in such a way that it provides at least two or three different resonant frequencies. The number of modes varies depending on the coupling strength, existing symmetries and frequency spacing compared to uncoupled oscillation systems. In relation to the embodiments shown in FIGS. 2-3, a mode number of between four and eight modes, for example, and between two and four modes according to FIG. 4 can be set.

A method for manufacturing the transponder label 2 can be carried out as follows according to the flowchart in FIG. 6: In a step S1, the carrier layer 20, for example in the form of a PET plastic film, is provided.

In a step S2, the RFID functional unit with the RFID chip 18 and the antenna structure 10 coupled to it is formed on the carrier layer 20. The antenna structure 10 can be formed on the carrier layer 20 by etching and/or printing aluminum and/or silver. The antenna structure 10 is formed with the two antenna sections 11 and 12 and the antenna loop 17 located between them, so that they are connected to each other by associated coupling points 19. At least one of the two antenna sections 11, 12 is formed with the first and second meandering antenna arms 13 and 14, so that these are arranged at a predetermined distance D1, D2, D3 from each other and are electromagnetically coupled to each other.

In this way, an embodiment of the transponder label 2 can be formed in which the antenna structure 10 enables multi-mode UHF RFID labeling for small primary containers in the pharmaceutical environment. When applied to relatively small primary containers, such as syringes, the transponder label 2 can be used to establish reliable RFID identification and electronic readout despite different liquid levels in the container 3. Through the targeted use of coupled resonators, the antenna structure 10 provides an increased number of possible oscillation modes, each of which can be read by a reader. The risk that the RFID functional unit cannot be reliably read due to a frequency shift can be significantly reduced by the described structure of the transponder label 2.

### REFERENCE SIGNS

1 system
2 transponder label
3 container
4 container closure
5 container body
10 antenna structure
11 first antenna section
12 second antenna section
13 first meandering antenna arm of the respective antenna section
14 second meandering antenna arm of the respective antenna section
15 first flat antenna part of the respective antenna section
16 second flat antenna part of the respective antenna section
17 inner antenna loop
18 RFID chip
19 coupling point between antenna section and antenna loop
20 carrier layer
A(i) outer width of the respective meandering antenna arm
B(i) inner width of the respective meandering antenna arm
C(i) height of the respective meandering antenna arm
D1 first distance between the meandering antenna arms
D2 second distance between the meandering antenna arms
D3 third distance between the meandering antenna arms
L longitudinal axis of the container
S(i) step of a method for producing a transponder label

1. A transponder label (2) for a container (3), comprising:
a carrier layer (20), and
an RFID functional unit comprising an RFID chip (18) and an antenna structure (10) coupled thereto and coupled to the carrier layer (20), wherein the antenna structure (10) comprises a first antenna section (11), a second antenna section (12) and an antenna loop (17) arranged between and coupled to the first and second antenna sections (11, 12), and wherein at least one of the two antenna sections (11, 12) comprises a first meander-shaped antenna arm (13) and a second meander-shaped antenna arm (14), which are arranged at a predetermined distance (D1, D2, D3) from each other and electromagnetically coupled to each other, so that a predetermined number of oscillation modes of the antenna structure (10) is set up.

2. The transponder label (10) according to claim 1, wherein both antenna sections (11, 12) each comprise a first meander-shaped antenna arm (13) and a second meander-shaped antenna arm (14), which are each arranged at a predetermined distance (D1, D2, D3) from one another and are electromagnetically coupled to one another.

3. The transponder label (10) according to claim 1, wherein the respective first antenna arm (13) and the respective second antenna arm (14) have a rectangular meander shape, each comprising a plurality of rectilinear sections of predetermined length (A1, A2, B1, B2, C1, C2).

4. The transponder label (10) according to claim 1, wherein at least one of the antenna arms (13, 14) comprises a flat antenna part (15, 16) at a free end.

5. The transponder label (10) according to claim 1, wherein the respective first antenna arm (13) and the respective second antenna arm (14) are coupled to the inner antenna loop (17) at different coupling points (19).

6. The transponder label (10) according to claim 1, wherein the respective first antenna arm (13) and/or the respective second antenna arm (14) have a width between 150-1000 μm.

7. The transponder label (10) according to claim 1, wherein the respective first antenna arm (13) and/or the respective second antenna arm (14) have a total length between 20-120 mm.

8. The transponder label (10) according to claim 1, wherein the respective first antenna arm (13) and/or the respective second antenna arm (14) have elongated sections with a length (C1, C2) between 10-20 mm.

9. The transponder label (10) according to claim 1, wherein a section length (A1, A2, B1, B2, C1, C2) and/or an overall length of the respective first and/or second antenna arm (13, 14) are formed in coordination with the container (3) to be labeled.

10. The transponder label (10) according to claim 1, wherein a line width of the respective first and/or second antenna arm (13, 14) is formed in coordination with the container (3) to be labeled.

11. The transponder label (10) according to the preceding claims claim 1, wherein the distance (D1, D2, D3) between the respective first and second antenna arms (13, 14) is designed in coordination with the container (3) to be labeled.

12. The transponder label (10) according to claim 9, wherein the line width, the section length (A1, A2, B1, B2, C1, C2), the total length and/or the distance (D1, D2, D3) are designed in coordination with a material, a content and/or a fill level of the container (3) to be labeled.

13. A system (1), comprising:
a container (3) with a container body (5) and a container closure (4), and
the transponder label (2) according to claim 1, which is connected to the container body (5) and/or the container closure (4).

14. A method for producing a transponder label (2) for a container (3), comprising:
providing a carrier layer (20), and
forming an RFID functional unit with an RFID chip (18) and an antenna structure (10) coupled thereto on the carrier layer (20), wherein the antenna structure (10) is formed with a first antenna section (11), a second antenna section (12) and an antenna loop (17) arranged between and coupled to the first and second antenna sections (11, 12) and coupled thereto, and wherein at least one of the two antenna sections (11, 12) is formed with a first meander-shaped antenna arm (13) and a second meander-shaped antenna arm (14), so that these are arranged at a predetermined distance (D1, D2, D3) from each other and are electromagnetically coupled to each other.

15. The method according to claim 14, wherein the antenna structure (10) of the RFID functional unit is formed on the carrier layer (20) by means of etching and/or printing.
